(19) United States
(12) Patent Application Publication
(10) Pub. No.: US 2026/0039515 A1
(43) Pub. Date: Feb. 5, 2026

(54) INTERFACE HAVING SELECTABLE EQUALIZATION MODES

(71) Applicant: Micron Technology, Inc., Boise, ID (US)

(72) Inventors: Taylor Loftsgaarden, Eden Prairie, MN (US); Nathan D. Henningson, Minneapolis, MN (US)

(21) Appl. No.: 19/267,888

(22) Filed: Jul. 14, 2025

Related U.S. Application Data
(60) Provisional application No. 63/677,322, filed on Jul. 30, 2024.
(60) Provisional application No. 63/787,151, filed on Apr. 11, 2025.

(51) Int. Cl. H04L 25/03; H04L 25/49

(52) U.S. Cl. CPC H04L 25/03057; H04L 25/4917

(57) ABSTRACT

Various embodiments of the present disclosure relate to apparatuses and methods for interfaces capable of switching between different equalization modes, such as Decision Feedback Equalization (DFE). An interface circuitry can include a DFE receiver that can selectively receive different control signals, which are utilized in resolving symbols in different equalization modes.

This application claims the benefit of U.S. Provisional Application No. 63/787,151, filed on, and U.S. Provisional Application No. 63/677,322, filed on Jul. 30, 2024, the contents of which are incorporated herein by reference.

### TECHNICAL FIELD

Embodiments of the disclosure relate generally to electronic systems, and more specifically, relate to apparatuses and methods for interfaces having selectable equalization modes.

### BACKGROUND

Various types of electronic devices such as logic circuits may store and process data. A logic circuit is an electronic circuit that processes digital signals or binary information, which can take on two possible values (usually represented as 0 and 1). The logic circuit can use logic gates to manipulate and transform the signals or binary information. Digital logic circuits can be used in a wide range of electronic devices including, for example, computers, calculators, digital clocks, and many other electronic devices that employ digital processing. Digital logic circuits can be designed to perform specific logical operations on digital inputs to generate digital outputs, and, in some instances, can be combined to form more complex circuits to perform more complex operations.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory system having selectable equalization modes in accordance with various embodiments of the present disclosure.

FIGS. 2A-1 and 2A-2 are block diagrams illustrating a portion of an interface having selectable equalization modes in accordance with various embodiments of the present disclosure.

FIGS. 2B-1 and 2B-2 are block diagrams illustrating another portion of an interface having selectable equalization modes in accordance with various embodiments of the present disclosure.

FIGS. 2C-1 and 2C-2 are block diagrams illustrating another portion of an interface having selectable equalization modes in accordance with various embodiments of the present disclosure.

FIG. 3 illustrates an eye diagram illustrating a multi-level signal in accordance with various embodiments of the present disclosure.

FIG. 4 illustrates an example method for switching among multiple equalization modes in accordance with various embodiments of the present disclosure.

### DETAILED DESCRIPTION

Aspects of the present disclosure are directed to apparatuses and methods for interfaces capable of switching between different equalization modes. Various electronic components (e.g., memory chips, controller chips, processor chips, etc.) communicate with each other via signals (e.g., data signals) transmitted across channels between a physical layer interface (PHY), such as an M-PHY (e.g., MIPI M-PHY), which can include a serializer/deserializer (SerDes), for example.

Such interfaces can often include sampling latches, which may also be referred to as “slicers” or clocked comparators, which are to capture and hold the signals received at the interface to allow conversion of analog signals (e.g., differential signals) to digital signals. The digital outputs of the sampling latches can be used to provide various functions including clock data recovery (CDR) edge sampling, vertical eye monitoring, and decision feedback equalization (DFE), for example.

The signals received at the sampling latches can be “modulated signals” that have undergone a modulation process, such as Pulse Amplitude Modulation (e.g., PAM2, PAM4, etc.). Modulation is a technique used in communication systems to encode information onto a carrier wave, making it suitable for transmission over a communication channel. As used herein, “PAM4” is a modulation technique that uses four amplitude levels to represent two bits per symbol, while “PAM2” is a modulation technique that uses two amplitude levels to represent one bit per symbol. PAM4 (as compared to PAM2) can be employed to increase data rates within a given bandwidth by transmitting more information in each symbol. Further, as used herein, the term “symbol” refers to a basic unit of information that represents a discrete value or state. Symbols can be used to convey information in digital systems by encoding data into specific patterns or states.

The modulation techniques, such as PAM4, can introduce challenges related to intersymbol interference (ISI) due to the increased complexity of the modulation scheme. To compensate for the ISI and improve the accuracy of symbol detection in PAM4 signals, various equalization techniques, such as Decision feedback equalization (DFE), can be deployed on the PHY (e.g., on the signals held at the sampling latches). The equalization is a signal processing technique used in communication systems to mitigate the effects of ISI. ISI occurs when symbols in a digital communication system overlap in time, making it difficult to accurately decode the transmitted information.

PAM4 and DFE can be often used together in high-speed communication systems, especially in scenarios where higher data rates are required, such as in data center interconnects and high-speed serial interfaces. PAM4 modulation increases data rates by using multiple amplitude levels, and DFE is employed to address the resulting ISI challenges. However, the interface that employes both PAM4 and DFE can be costly/power inefficient since the number of levels for each tap doubles from 2 to 4 (as compared to utilizing PAM2 instead of PAM4). Further, the PAM4 implementations along with DFE can increase design complexity in achieving effective equalization within the duration of one symbol (“1UI”). As used herein, the term “tap” refers to a number of memory elements used in the equalization process, such as DFE. For example, in a “1-tap DFE”, there is a single memory element (e.g., the most recent symbol) which the DFE makes decisions based on, while in a “2-tap DFE”, there are two memory elements (e.g., the two most recent symbols) which the DFE makes decisions based on.

In some approaches, an M-PHY rather uses a 1-tap speculative DFE (along with various modulation techniques, such as PAM4, Non-Return-To-Zero (NRZ), etc.) to reduce the power consumption. However, a reduced-tap DFE can have limitations in handling more complex ISI scenarios or longer-duration ISI. Further, NRZ signals can typically suffer from ISI due to their longer bit durations, and a 1-tap DFE may not be sufficient to fully equalize the channel. Accordingly, more flexible schemes that can selectively benefit from 1-tap or 2-tap equalization techniques are desired.

Various embodiments of the present disclosure address the above and other deficiencies by providing a DFE receiver that can selectively operate in a 1-tap DFE mode or 2-tap DFE mode for receiving PAM (e.g., PAM4) signals. In a number of embodiments, the DFE receiver uses a common set of sampling latches for both DFE modes, which allows two different DFE modes to operate at the substantially same power. When switching from one DFE mode to another DFE mode, the samples can be compared to different thresholds and a symbol of the samples can be resolved based on different inputs (e.g., corresponding to previously resolved symbols), which allows samples to be resolved in different manners (e.g., 1-tap, 2-tap, etc.).

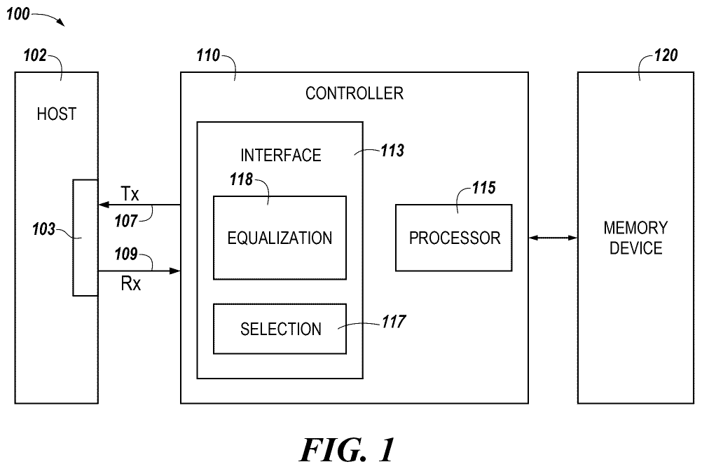

FIG. 1 illustrates an example computing environment that includes an electronic system (e.g., a memory system) having an interface 113 having selectable equalization modes in accordance with various embodiments of the present disclosure. In this example, the memory system comprises a controller 110 (e.g., a system controller) coupled to one or more memory devices 120.

In some embodiments, the memory system is a storage system. An example of a storage system is a solid-state drive (SSD), hard disk drive (HDD), etc. In some embodiments, the memory system can a hybrid memory/storage sub-system. In general, the computing environment 100 shown in FIG. 1 can include a host 102 (e.g., a host system) that uses the memory system. For example, the host 102 can write data to the memory devices 120 and read data from the memory devices 120 via controller 110.

The host 102 can be a computing device such as a desktop computer, laptop computer, network server, mobile device, or other such computing device that includes a memory and a processing device. The host 102 is coupled to the memory system via a physical interface (PHY). In this example, the physical interface between the host 102 and memory system includes interface circuitry 103 of the host 102 and interface circuitry 113 of the controller 110 and may be referred to as a physical host interface to distinguish it from a physical interface between the controller 110 and the memory devices 120, which may be referred to as a memory interface. As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interfaces include, but are not limited to, a serial advanced technology attachment (SATA) interface, a peripheral component interconnect express (PCIe) interface, a universal flash storage (UFS) interface, a universal serial bus (USB) interface, Fibre Channel, Serial Attached SCSI (SAS), a mobile industry processor interface (MIPI), etc. The physical host interface can be used to transmit data between the host 102 and the memory system 110. The host 102 can further utilize a memory interface such as a Non-Volatile Memory Express (NVMe) interface or an Open NAND Flash Interface (ONFI), for example, to access the memory devices.

In general, the physical host interface can provide an interface for passing signals (e.g., control, address, data, etc.) between the memory system and the host 102. As described further below, the host interface is used for communication between the host 102 and controller 110 over a number of channels that can include transmission link (Tx) 107 and receiver link (Rx) 109 pairs. The host interface can modulate/demodulate signals being communicated to the interface 113 using a PAM (e.g., PAM 4-level), although embodiments are not so limited. The data can be received as differential signals, with the electrical signals being provided as respective differential pairs. The signals provided across the channels can experience distortion due to transmission line reflections and/or intersymbol interference (ISI), for example. The interface circuitry (e.g., 113) can include equalization circuitry to compensate for high frequency losses and transmission reflections.

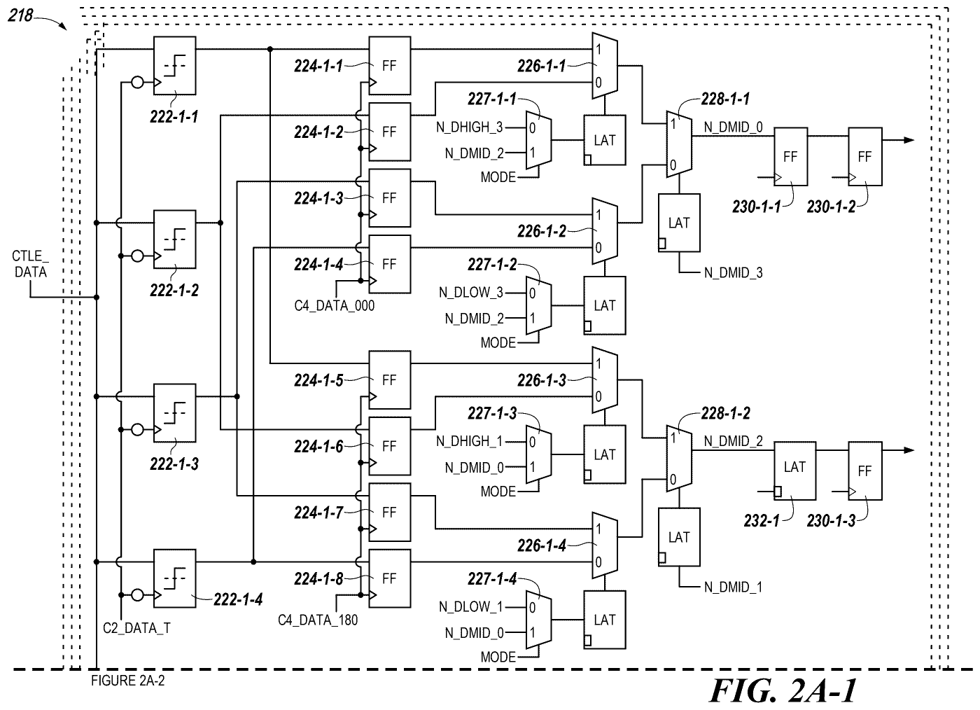

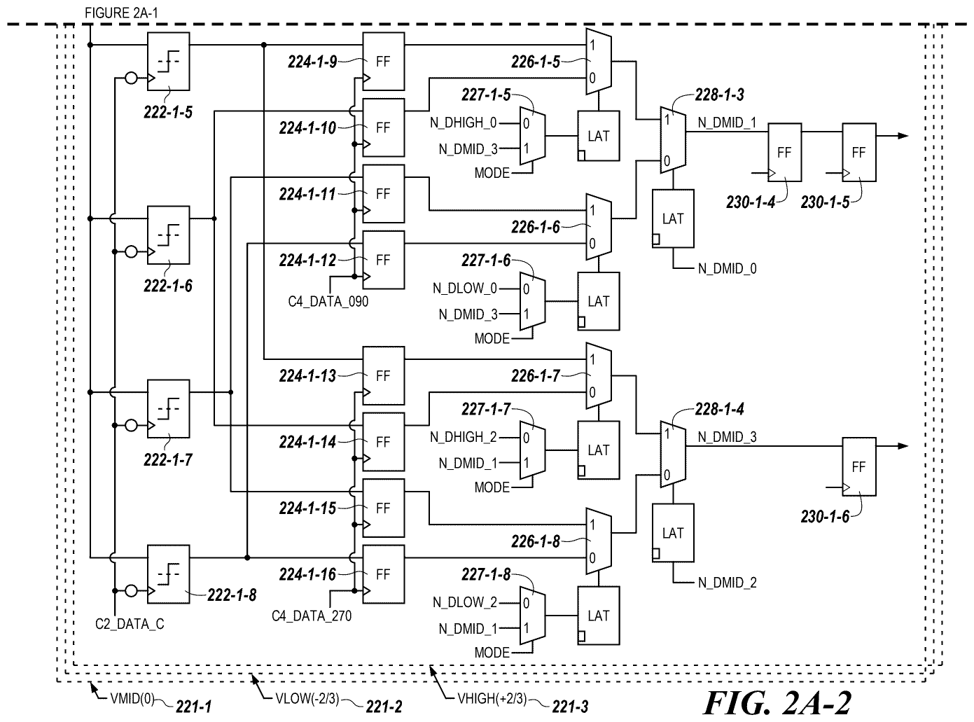

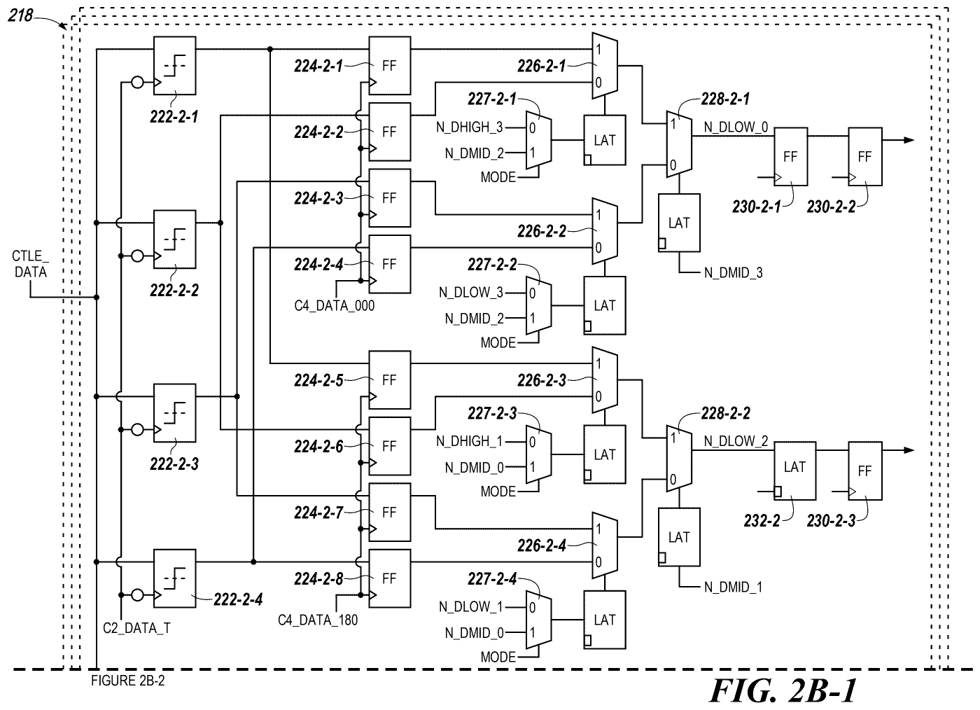

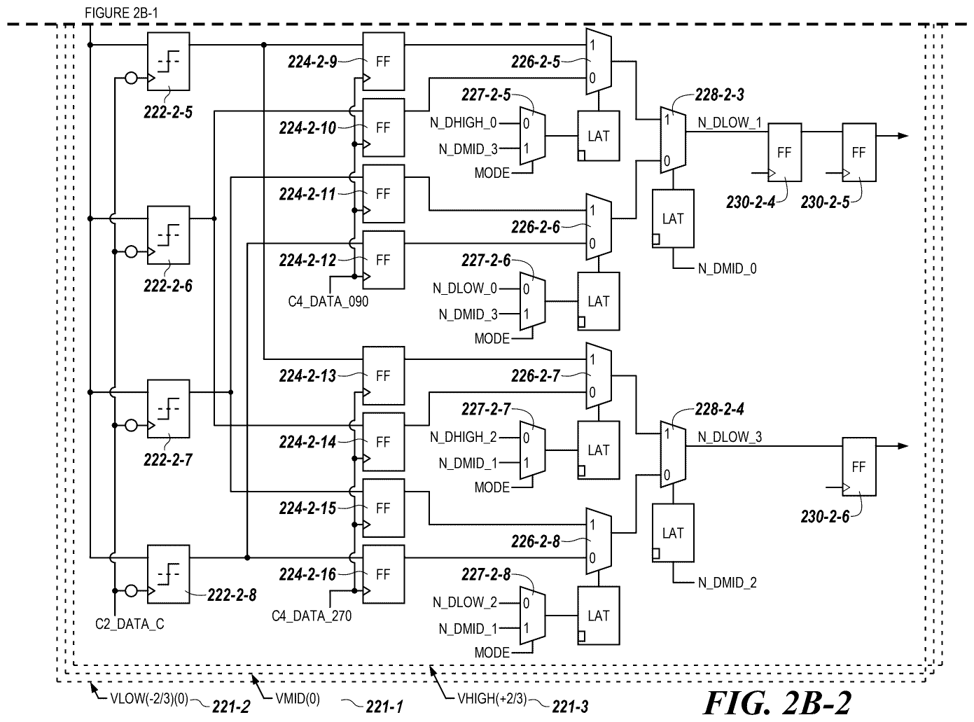

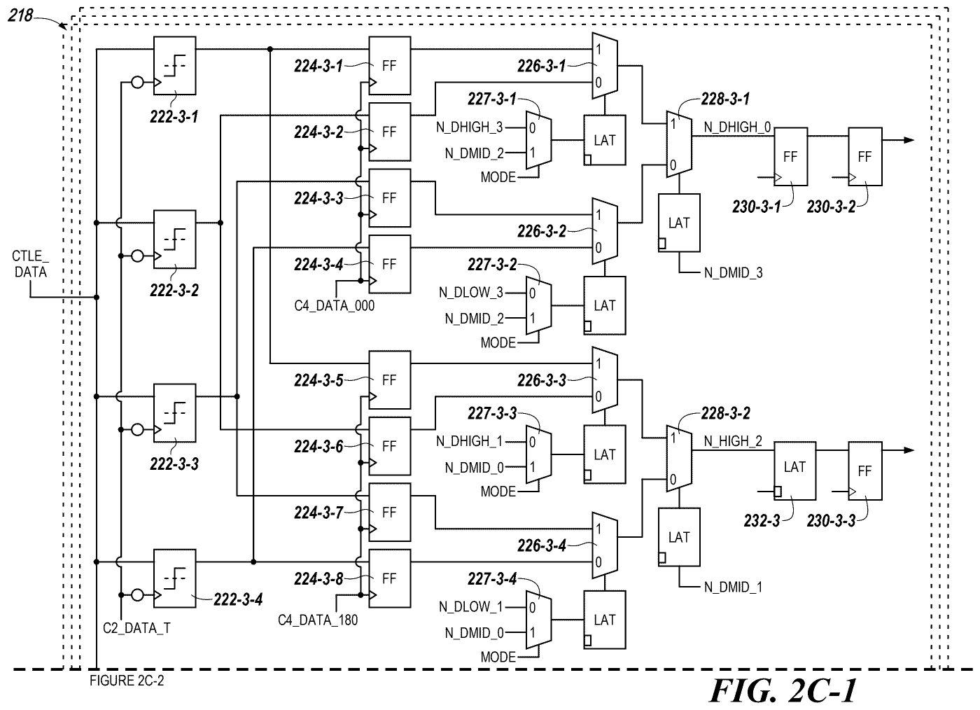

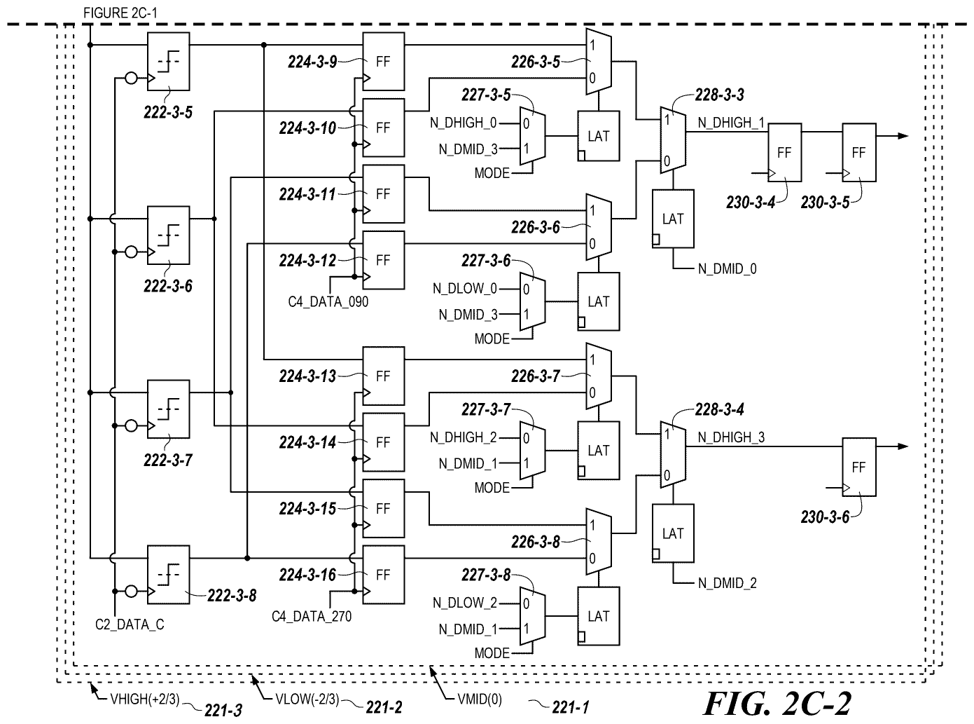

The interface circuitry 113 includes equalization circuitry 118 that can be used for the equalization of the signals received from the host 102 and sampled in the sampling latches (e.g., sampling latches 222 illustrated in FIGS. 2A-2C). Although embodiments are not so limited, the equalization that can be performed at the equalization circuitry 118 can be a decision feedback equalization (DFE), such as a 1-tap DFE or a 2-tap DFE. In this example, the equalization circuitry 118 can be alternatively referred to as a DFE receiver. The interface circuitry 113 further includes selection component 117, which can selectively cause the equalization circuitry 118 to operate in one of different equalization modes (e.g., 1-tap DFE or 2-tap DFE modes). The selection component 104 can include special purpose circuitry in the form of an ASIC, FPGA, state machine, and/or other logic circuitry.

For example, to cause the equalization circuitry 118 to operate with a 1-tap DFE, the selection component 117 can selectively cause the equalization circuitry 118 to receive and operate signals corresponding to data signals that are sampled at a preceding sampling time. For example, to cause the equalization circuitry 118 to operate with a 2-tap DFE, the selection component 117 can selectively cause equalization circuitry 118 to receive and operate signals corresponding to data signals that are sampled at two different preceding sampling times. Further details of how to selectively cause the equalization circuitry 118 to operate in one of different equalization modes are further described in connection with FIGS. 2A-2C. While the equalization circuitry 118 can selectively operate with different “taps”, two different equalization modes can still be performed on the same “samples” (e.g., data signals sampled at the sampling latches 222 illustrated in FIGS. 2A-2C), which allows the equalization circuitry 118 to operate at the same power regardless of whether the equalization circuitry 118 operates with a 1-tap DFE or a 2-tap DFE. Whether to operate the equalization circuitry 118 with a 1-tap DFE or a 2-tap DFE can be determined based on comparison of various parameters associated with benefits and/or costs associated with the equalization modes.

The memory devices 120 can include various combinations of different types of non-volatile memory devices and/or volatile memory devices. An example of non-volatile memory devices includes a NAND flash memory. The memory devices 120 can include one or more arrays of memory cells and other circuitry not shown (e.g., an internal controller, decode circuitry, sense amplifiers, etc.). Embodiments are not limited to a particular type of memory. For example, the memory devices 120 can include random access memory (RAM), read-only memory (ROM), dynamic random access memory (DRAM), synchronous dynamic random access memory (SDRAM), phase change memory (PCM), magneto random access memory (MRAM), NOR flash memory, electrically erasable programmable read-only memory (EEPROM), and a cross-point array of non-volatile memory cells (e.g., 3D cross-point memory).

The controller 110 can communicate with the memory devices 120 to perform operations such as reading data, writing data, or erasing data at the memory devices 120 and other such operations. The controller 110 include a microcontroller, special purpose logic circuitry (e.g., a field programmable gate array (FPGA), an application specific integrated circuit (ASIC), etc.), or other suitable processing circuitry. The controller 110 can include a processing device (e.g., processor 115) configured to execute instructions stored in local memory (not shown).

In general, the controller 110 can receive commands or operations from the host 102 and can convert the commands or operations into instructions or appropriate commands to achieve the desired access to the memory devices 120. The controller 110 can be responsible for other operations such as wear leveling operations, garbage collection operations, error detection and error-correcting code (ECC) operations, encryption operations, caching operations, and address translations between a logical block address and a physical block address that are associated with the memory devices 120.

Although the memory system (e.g., controller 110 and memory device 120) is shown as physically separate from the host 102, in a number of embodiments the memory system can be embedded within the host 102. Alternatively, the memory system 110 can be removable from the host 102. Also, the controller 110 and memory device(s) 120 can be located on a same chip, in various embodiments.

While the example interface circuitry shown in FIG. 1 has been described in association with communication between a host (e.g., a host chip) and a memory system (e.g., an ASIC controller of a memory system), embodiments are not so limited. For example, the interface circuitry 113 may be deployed on a component (e.g., chip) other than a controller.

As used herein, an “apparatus” can refer to various structural components. For example, the computing environment shown in FIG. 1 can be considered an apparatus. Alternatively, the host 102, the controller 110, and the interface circuitry 118 might each separately be considered an apparatus.

FIGS. 2A-1 and 2A-2 (collectively referred to as FIG. 2A) are block diagrams illustrating a portion of an equalization circuitry 218 capable of switching between different equalization modes (alternatively referred to as operation modes) in accordance with various embodiments of the present disclosure. The equalization circuitry 218 at least partially illustrated in FIG. 2A can be analogous to a DFE receiver, which can be part of a deserializer portion of a SerDes component of an M-PHY interface (e.g., the interface 113 illustrated in FIG. 1).

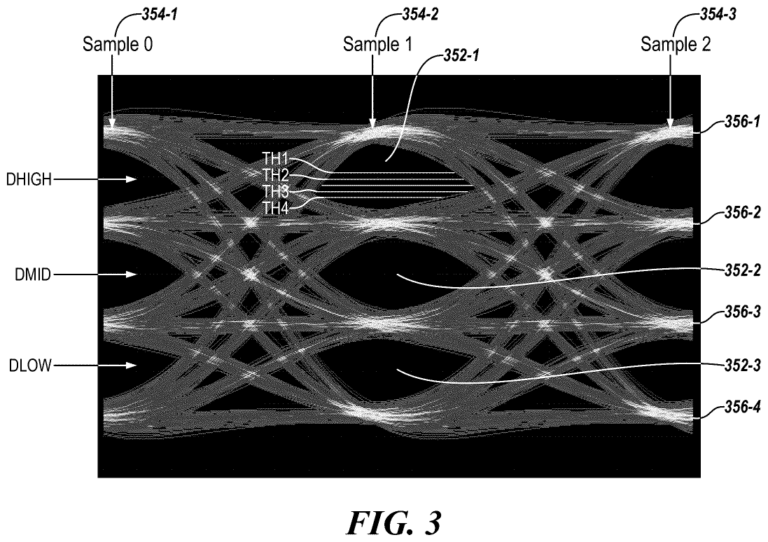

As illustrated in FIG. 2A, the equalization circuitry 218 can include more than one “slicer.” Each slicer can correspond to one of a number of “data eyes” (such as data eyes 352-1, 352-2, and 352-3 illustrated in FIG. 3) of PAM4 signals. For example, the slicer 221-1 (as illustrated in detail in FIG. 2A) is to indicate whether a PAM4 signal sampled at the slicer 221-1 is above or below one or more thresholds (respectively corresponding to sampling latches of the slicer 221-1) within the data eye 352-2, while the slicers 221-2 and 221-3 (respectively illustrated in FIGS. 2B and 2C) are indicate whether a PAM4 signal sampled at the respective slicer 221-2, 221-3 is above or below one or more thresholds within the other data eyes, such as data eyes 352-1 and 352-3. Further details of the slicers 221-2 and 221-3 are described in connection with FIGS. 2B and 2C.

The differential data signals may have been terminated, filtered, amplified, equalized, etc. prior to being received by one or more sampling latches 222-1-1, . . . , 222-1-8 (referred to collectively as sampling latches 222-1). For example, as represented by “CTLE_DATA” shown in FIG. 2A, the differential signals can be equalized by a continuous time linear equalizer (CTLE) technique prior to being received at the sampling latches 222-1, although embodiments are not so limited.

As illustrated in FIG. 2A, the equalization circuitry 218 includes two sets of sampling latches, such as a set of sampling latches 222-1-1, . . . , 222-1-4 and a set of sampling latches 222-1-5, . . . , 222-1-8. The two sets of sampling latches 222-1 operate based on differential clock signals. For example, as illustrated in FIG. 2A, the set of sampling latches 222-1-1, . . . , 222-1-4 operates based on “C2_DATA_T” clock signals and the set of sampling latches 222-1-5, . . . , 222-1-8 operates based on “C2_DATA_C” clock signals with “C2_DATA_T” and “C2_DATA_C” being differential clock signals. Accordingly, the set of sampling latches 222-1-1, . . . , 222-1-4 captures (e.g., receives) “CTLE_DATA” based on clock signals “C2_DATA_T”, while the set of sampling latches 222-1-5, . . . , 222-1-8 captures (e.g., receives) “CTLE_DATA” based on clock signals “C2_DATA_C”.

A respective sample (e.g., data signals sampled at respective sampling latches 222-1) of each set of sampling latches 222-1 can correspond to “even” or “odd” samples. For example, the samples stored and being processed at the set of sampling latches 222-1-1, . . . , 222-1-4 can correspond to “even” samples, while the samples stored and being processed at the set of sampling latches 222-1-5, . . . , 222-1-8 can correspond to “odd” samples. These even/odd sampling can allow resolving of a current symbol (e.g., to be resolved by the “odd” sampling latches) based on a previous symbol (e.g., that was previously resolved by the “even” sampling latches).

The “CTLE_DATA” signals received at the sampling latches 222-1 can be compared to respective thresholds (alternatively referred to as “sampling thresholds”) of the sampling latches 222-1. The thresholds can be programmable (e.g., adjustable) such that, for example, the thresholds can be programmed to be different depending on what operation modes the equalization circuitry 218 is in.

For example, in one operation mode (e.g., 1-tap DFE mode), the “CTLE_DATA” signals received at the sampling latches 222-1-1 and 222-1-5 can be compared to the threshold +C1; the “CTLE_DATA” signals received at the sampling latches 222-1-2 and 222-1-6 can be compared to the threshold +C1/3; the “CTLE_DATA” signals received at the sampling latches 222-1-3 and 222-1-7 can be compared to the threshold −C1/3; and the “CTLE_DATA” signals received at the sampling latches 222-1-4 and 222-1-8 can be compared to the threshold −C1. This 1-tap DFE operation operates based on a single/previously resolved bit corresponding to a coefficient “C1”. A 1-tap operation mode illustrated in FIGS. 2A-2C and 3 can correspond to 4-level for each tap (e.g., four threshold levels for “C1”), although embodiments are not so limited.

For example, in another operation mode (e.g., 2-tap DFE mode), the “CTLE_DATA” signals received at the sampling latches 222-1-1 and 222-1-5 can be compared to the threshold 2/3(+C1+C2); the “CTLE_DATA” signals received at the sampling latches 222-1-2 and 222-1-6 can be compared to the threshold 2/3(+C1−C2); the “CTLE_DATA” signals received at the sampling latches 222-1-3 and 222-1-7 can be compared to the threshold 2/3(−C1+C2); and the “CTLE_DATA” signals received at the sampling latches 222-1-4 and 222-1-8 can be compared to the threshold 2/3(−C1−C2). Accordingly, outputs from sampling latches 222-1 corresponds to a result (e.g., “0” or “1”) of the comparison between the respective thresholds and samples. This 2-tap DFE operation operates based on two previously resolved bit respectively corresponding to coefficients “C1” and “C2”. A 2-tap operation mode illustrated in FIGS. 2A-2C and 3 can correspond to 2-level for each tap (e.g., two threshold levels for “C1” and “C2” each), although embodiments are not so limited.

As illustrated in FIG. 2A, each sampling latch 222-1 is coupled to two flip flops 224-1 respectively such that output signals of the sampling latches 222-1 are provided to respective flip flops 224-1. For example, the sampling latch 222-1-1 is coupled to the flip flops 224-1-1 and 224-1-5; the sampling latch 222-1-2 is coupled to the flip flops 224-1-2 and 224-1-6; the sampling latch 222-1-3 is coupled to the flip flops 224-1-3 and 224-1-7; and the sampling latch 222-1-4 is coupled to the flip flops 224-1-4 and 224-1-8. Further, for example, the sampling latch 222-1-5 is coupled to the flip flops 224-1-9 and 224-1-13; the sampling latch 222-1-6 is coupled to the flip flops 224-1-10 and 224-1-14; the sampling latch 222-1-7 is coupled to the flip flops 224-1-11 and 224-1-15; and the sampling latch 222-1-8 is coupled to the flip flops 224-1-12 and 224-1-16.

Each set of eight flip flops operates based on differential clock signals. For example, a set of flip flops 224-1-1, . . . , 224-1-4 and a set of flip flops 224-1-5, . . . , 224-1-8 operates based on differential clock signals “C4_DATA_000” and “C4_DATA_180” respectively, while a set of flip flops 224-1-9, . . . , 224-1-12 and a set of flip flops 224-1-13, . . . , 224-1-16 operates based on differential clock signals “C4_DATA_090” and “C4_DATA_270” respectively. Accordingly, the set of flip flops 224-1-1, . . . , 224-1-4 captures (e.g., receives) and process the respective signals based on clock signals “C4_DATA_000”; the set of flip flops 224-1-5, . . . , 224-1-8 captures (e.g., receives) and process the respective signals based on clock signals “C4_DATA_180”; the set of flip flops 224-1-9, . . . , 224-1-12 captures (e.g., receives) and process the respective signals based on clock signals “C4_DATA_090”; and the set of flip flops 224-1-13, . . . , 224-1-16 captures (e.g., receives) and process the respective signals based on clock signals “C4_DATA_270”.

The flip flops 224-1 are further respectively coupled to selectors (e.g., multiplexors) 226-1-1, . . . , 226-1-8 (alternatively referred to as “selectors 226-1”). For example, the flip flops 224-1-1 and 224-1-2 are coupled to the selector 226-1-1; the flip flops 224-1-3 and 224-1-4 are coupled to the selector 226-1-2; the flip flops 224-1-5 and 224-1-6 are coupled to the selector 226-1-3; the flip flops 224-1-7 and 224-1-8 are coupled to the selector 226-1-4. Further, for example, the flip flops 224-1-9 and 224-1-10 are coupled to the selector 226-1-5; the flip flops 224-1-11 and 224-1-12 are coupled to the selector 226-1-6; the flip flops 224-1-13 and 224-1-14 are coupled to the selector 226-1-7; the flip flops 224-1-15 and 224-1-16 are coupled to the selector 226-1-8.

The DFE receiver further includes selectors 227-1, . . . , 227-8 (collectively referred to as selectors 227) that respectively select one of inputs depending on which operation mode the DFE receiver of the equalization circuitry 218 is in. For example, when the DFE receiver is in a first operation mode, the selectors 227 respectively select and output “N_DHIGH_3”, “N_DLOW_3”, “N_DHIGH_1”, “N_DLOW_1”, “N_DHIGH_0”, “N_DLOW_0”, “N_DHIGH_2”, and “N_DLOW_2”, which can be respectively input to the selectors 226-1-1, . . . , 226-1-8 as control signals. For example, when the DFE receiver is in a first operation mode, the selectors 227 respectively select and output when the DFE receiver is in a first operation mode, the selectors 227 respectively select and output, “N_DMID_2”, “N_DMID_2”, “N_DMID_0”, “N_DMID_0”, “N_DMID_33”, “N_DMID_3”, “N_DMID_1”, and “N_DMID_1” which can be respectively input to the selectors 226-1-1, . . . , 226-1-8 as control signals. These control signals input to the selectors 226-1 can corresponds to data signals that are sampled sequentially and in a particular order (e.g., in an order of N_DHIGH_0″, “N_DHIGH_1”, “N_DHIGH_2”, “N_DHIGH_3”, and back to “N_DHIGH_0”; in an order of N_DMID_0″, “N_DMID_1”, “N_DMID_2”, “N_DMID_3” and back to “N_DMID_0”; or N_DLOW_0″, “N_DLOW_1”, “N_DLOW_2”, “N_DLOW_3”, and back to “N_DLOW_0”).

Therefore, each selector 226-1 selects one of its inputs based on a respective control signal. For example, in a first operation mode, such as “1-tap” DFE equalization mode, the selectors 226-1-5 and 226-1-6 respectively select one of its inputs based on a respective control signal “N_DHIGH_0” and “N_DLOW_0”; the selectors 226-1-3 and 226-1-4 respectively select one of its inputs based on a respective control signal “N_DHIGH_1” and “N_DLOW_1”; the selectors 226-1-7 and 226-1-8 respectively select one of its inputs based on a respective control signal “N_DHIGH_2” and “N_DLOW_2”; and the selectors 226-1-1 and 226-1-2 respectively select one of its inputs based on a respective control signal “N_DHIGH_3” and “N_DLOW_3”. Further, for example, in a second operation mode, such as “2-tap” DFE equalization mode, the selectors 226-1-3 and 226-1-4 respectively select one of its inputs based on a respective control signal “N_DMID_0”; the selectors 226-1-7 and 226-1-8 respectively select one of its inputs based on a respective control signal “N_DMID_1”; the selectors 226-1-1 and 226-1-2 respectively select one of its inputs based on a respective control signal “N_DMID_2”; and the selectors 226-1-5 and 226-1-6 respectively select one of its inputs based on a respective control signal “N_DMID_3”.

Output signals from the selectors 226-1 can be respectively provided (e.g., input) to selectors 228-1-1, . . . , 228-1-4 (alternatively referred to as “selectors 228-1”). For example, one of output signals from flip flops 224-1-1 and 224-1-2 selected at the selector 226-1-1 are provided to the selector 228-1-1; one of output signals from flip flops 224-1-3 and 224-1-4 selected at the selector 226-1-2 are provided to the selector 228-1-2; one of output signals from flip flops 224-1-5 and 224-1-6 are selected at the selector 226-1-3 provided to the selector 228-1-3; and one of output signals from flip flops 224-1-7 and 224-1-8 selected at the selector 226-1-4 are provided to the selector 228-1-4. The selectors 228-1-1, . . . , 228-1-4 can select one of its inputs based on “N_DMID_3”, “N_DMID_1”, “N_DMID_0”, and “N_DMSB_2”, respectively and as illustrated in FIG. 2A.

Output signals of the selectors 228-1-1, . . . , 228-1-4 (e.g., “N_DMID_0”, “N_DMID_2”, “N_DMID_1”, and “N_DMID_3”, respectively) can correspond to “decision variables”, which are indicative of whether the respective sampled signals (e.g., signals sampled at the sampling latches 222-1) are above or below one or more thresholds of the sampling latches 222-1. The indication (along with the other indications from decision variables of the other slicers 221-2 and 221-3) can be used to further determine a data value of the sampled PAM4 signal (e.g., “00”, “01”, “10”, or “11”). The output signals of the selectors 228-1-1, . . . , 228-1-4 can be further transmitted respectively to flip flops (e.g., flip flops 230-1-1, . . . , 230-1-6), latches (e.g., 232-1), etc. to align timing at which the output signals are transmitted to a subsequent component of the equalization circuitry 218.

The selectors 226-1 and/or 228-1 are cross-coupled to one another such that an output signal of one selector 228-1 can be provided (e.g., input) to respective selectors 226-1 and/or to the other selector 228-1 as a control signal based on which the selectors 226-1, 228-1 selects one of its inputs. For example, in the first operation mode, an output of the selector 228-1-1 can be input to the selectors 226-1-5, 226-1-6, and 228-1-3; an output of the selector 228-1-2 can be input to the selectors 226-1-7, 226-1-8, and 228-1-4; an output of the selector 228-1-3 can be input to the selectors 226-1-3, 226-1-4, and 228-1-2; and an output of the selector 228-1-4 can be input to the selectors 226-1-1, 226-1-2, and 228-1-1. For example, in the second operation mode, an output of the selector 228-1-1 can be input to the selectors 226-1-3, 226-1-4, and 228-1-3; an output of the selector 228-1-2 can be input to the selectors 226-1-1, 226-1-2, and 228-1-4; an output of the selector 228-1-3 can be input to the selectors 226-1-7, 226-1-, and 228-1-2; and an output of the selector 228-1-4 can be input to the selectors 226-1-5, 226-1-6, and 228-1-1.

The first operation mode can correspond to a “1-tap” equalization (e.g., DFE) mode, in which one of inputs to the selectors 228-1 is selected based on one previous (e.g., preceding) symbol. For example, in the “1-tap” equalization mode, the output of the selector 228-1-1 corresponds to one of samples from sampling latches 222-1 that is selected based on “N_DLOW_3”, “N_DHIGH_3” (input to the selectors 226-1-1 and 226-1-2), and “N_DMID_3” (input to the selector 228-1-1) that are sampled approximately at the same sampling time; the output of the selector 228-1-2 corresponds to one of samples from sampling latches 222-1 that is selected based on “N_DLOW_1”, “N_DHIGH_1” (input to the selectors 226-1-3 and 226-1-4), and “N_DMID_1” (input to the selector 228-1-2) that are sampled approximately at the same sampling time; the output of the selector 228-1-3 corresponds to one of samples from sampling latches 222-1 that is selected based on “N_DLOW_0”, “N_DHIGH_0” (input to the selectors 226-1-5 and 226-1-6), and “N_DMID_0” (input to the selector 228-1-3) that are sampled approximately at the same sampling time; and the output of the selector 228-1-4 corresponds to one of samples from sampling latches 222-1 that is selected based on “N_DLOW_2”, “N_DHIGH_2” (input to the selectors 226-1-7 and 226-1-88), and “N_DMID_2” (input to the selector 228-1-4) that are sampled approximately at the same sampling time.

The second operation mode can correspond to a “2-tap” equalization (e.g., DFE) mode, in which one of inputs to the selectors 228-1 is selected based on two previous (preceding) symbols. For example, in the “2-tap” equalization mode, the output of the selector 228-1-1 corresponds to one of samples from sampling latches 222-1 that is selected based on “N_DMID_2” (input to the selectors 226-1-1 and 226-1-2) and “N_DMID_3” (input to the selector 228-1-1) that are sequentially sampled at different (e.g., two preceding) sampling times; the output of the selector 228-1-2 corresponds to one of samples from sampling latches 222-1 that is selected based on “N_DMID_0” (input to the selectors 226-1-3 and 226-1-4) and “N_DMID_1” (input to the selector 228-1-2) that are sequentially sampled at different (e.g., two preceding) sampling times; the output of the selector 228-1-3 corresponds to one of samples from sampling latches 222-1 that is selected based on “N_DMID_3” (input to the selectors 226-1-5 and 226-1-6) and “N_DMID_0” (input to the selector 228-1-3) that are sequentially sampled at different (e.g., two preceding) sampling times; and the output of the selector 228-1-4 corresponds to one of samples from sampling latches 222-1 that is selected based on “N_DMID_1” (input to the selectors 226-1-7 and 226-1-88) and “N_DMID_2” (input to the selector 228-1-4) that are sequentially sampled at different (e.g., two preceding) sampling times.

FIGS. 2B-1 and 2B-2 (collectively referred to as FIG. 2B) are block diagrams illustrating another portion of an interface capable of switching between different equalization modes in accordance with various embodiments of the present disclosure. The equalization circuitry 218 at least partially illustrated in FIG. 2B can be analogous to the equalization circuitry 118 illustrated in FIG. 1, which can be part of a deserializer portion of a SerDes component of an M-PHY interface (e.g., the interface 113 illustrated in FIG. 1).

The slicer 221-2 illustrated in FIG. 2B can be analogous to the slicer 221-2 illustrated in FIG. 2A except that the sampling latches 222 compares the samples based on different thresholds than those thresholds used at sampling latches 222 illustrated in FIG. 2A. For example, in one operation mode (e.g., 1-tap DFE mode), the “CTLE_DATA” signals received at the sampling latches 222-2-1 and 222-2-5 can be compared to the threshold −C1/3; the “CTLE_DATA” signals received at the sampling latches 222-2-2 and 222-2-6 can be compared to the threshold −C1; the “CTLE_DATA” signals received at the sampling latches 222-2-3 and 222-2-7 can be compared to the threshold −5/3*C1; and the “CTLE_DATA” signals received at the sampling latches 222-2-4 and 222-2-8 can be compared to the threshold −7/3*C1. For example, in another operation mode (e.g., 2-tap DFE mode), the “CTLE_DATA” signals received at the sampling latches 222-2-1 and 222-2-5 can be compared to the threshold 0; the “CTLE_DATA” signals received at the sampling latches 222-2-2 and 222-2-6 can be compared to the threshold −4/3*C2; the “CTLE_DATA” signals received at the sampling latches 222-2-3 and 222-2-7 can be compared to the threshold −4/3*C1; and the “CTLE_DATA” signals received at the sampling latches 222-2-4 and 222-2-8 can be compared to the threshold −4/3*(C1+C2). Accordingly, outputs from sampling latches 222 corresponds to a result (e.g., “0” or “1”) of the comparison between the respective thresholds and samples. These thresholds can be within the data eye 352-3 (illustrated in FIG. 3) of PAM4 signals.

While the sampling latches 221-2 operate based on different thresholds than those of the sampling latches 221-1, control signals being provided to the selectors 226-2-1, . . . , 226-2-8 (and/or selectors 227-2-1, . . . , 227-2-8) and selectors 228-2-1, . . . , 228-2-4 are analogous to the control signals being provided to the selectors 226-1-1, . . . , 226-1-8 (and/or selectors 227-1-1, . . . , 227-1-8) and selectors 228-1-1, . . . , 228-1-4. Accordingly, unlike the slicer 221-1 under the 1-tap operation mode, in which the selectors 228-1 are cross-coupled to one another, the selectors 228-2 are not cross coupled. For example, while the output of the selector 228-1-1 (of the slicer 228-1) is input to the selector 228-1-3 (of the slicer 228-1), the output of the selector 228-2-1 is not input to any one of the selectors 228-2. Rather, the selector 228-2-3 operates based on a control signal (“N_DMID_0” shown in FIG. 2B) provided from the selector 228-1-1. Similarly, the selectors 226-2 (when in a 2-tap DFE mode) and the selectors 228-2 select inputs based respectively on “N_DMID_0”, “N_DMID_1”, “N_DMID_2”, “N_DMID_3”, and “N_DMSB_0” provided from the slicer 221-1, as illustrated in FIG. 2B.

Rather, outputs of selectors 228-2 are provided to selectors 227-2 as shown in FIG. 2B. For example, an output of the selector 228-2-1 is provided to the selector 227-2-5; an output of the selector 228-2-2 is provided to the selector 227-2-7; an output of the selector 228-2-3 is provided to the selector 227-2-3; and an output of the selector 228-2-4 is provided to the selector 227-2-1. These outputs from the selectors 228-2 and provided to the selectors 227-2 are control signals being provided to the respective selectors 226 (e.g., selectors 226-2-1, 226-2-3, 226-2-5, and 226-2-7) in the 1-tap operation mode.

FIGS. 2C-1 and 2C-2 (collectively referred to as FIG. 2C) are block diagrams illustrating another portion of an interface capable of switching between different equalization modes in accordance with various embodiments of the present disclosure. The equalization circuitry 218 at least partially illustrated in FIG. 2C can be analogous to the equalization circuitry 118 illustrated in FIG. 1, which can be part of a deserializer portion of a SerDes component of an M-PHY interface (e.g., interface 113 illustrated in FIG. 1).

The slicer 221-3 illustrated in FIG. 2C can be analogous to the slicer 221-1 or 221-2 illustrated in FIGS. 2A and 2B except that the sampling latches 222 compares the samples based on different thresholds than those thresholds used at sampling latches 222 illustrated in FIG. 2A. For example, in one operation mode (e.g., 1-tap DFE mode), the “CTLE_DATA” signals received at the sampling latches 222-3-1 and 222-3-5 can be compared to the threshold +C1/3; the “CTLE_DATA” signals received at the sampling latches 222-3-2 and 222-3-6 can be compared to the threshold −C1/3; the “CTLE_DATA” signals received at the sampling latches 222-3-3 and 222-3-7 can be compared to the threshold −C1; and the “CTLE_DATA” signals received at the sampling latches 222-3-4 and 222-3-8 can be compared to the threshold −5/3*C1. For example, in another operation mode (e.g., 2-tap DFE mode), the “CTLE_DATA” signals received at the sampling latches 222-3-1 and 222-3-5 can be compared to the threshold 0; the “CTLE_DATA” signals received at the sampling latches 222-3-2 and 222-3-6 can be compared to the threshold −4/3*C2; the “CTLE_DATA” signals received at the sampling latches 222-3-3 and 222-3-7 can be compared to the threshold −4/3*C1; and the “CTLE_DATA” signals received at the sampling latches 222-3-4 and 222-3-8 can be compared to the threshold −4/3*(C1+C2). Accordingly, outputs from sampling latches 222 corresponds to a result (e.g., “0” or “1”) of the comparison between the respective thresholds and samples. These thresholds can be within the data eye 352-1 (illustrated in FIG. 3) of PAM4 signals.

While the sampling latches 221-3 operate based on different thresholds than those of the sampling latches 221-1, control signals being provided to the selectors 226-3-1, . . . , 226-3-8 (and/or selectors 227-3-1, . . . , 227-3-8) and selectors 228-3-1, . . . , 228-3-4 are analogous to the control signals being provided to the selectors 226-1-1, . . . , 226-1-8 (and/or selectors 227-1-1, . . . , 227-1-8) and selectors 228-1-1, . . . , 228-1-4. Accordingly, unlike the slicer 221-1 under the 1-tap operation mode, in which the selectors 228-1 are cross-coupled to one another, the selectors 228-3 are not cross coupled. For example, while the output of the selector 228-1-1 (of the slicer 228-1) is input to the selector 228-1-3 (of the slicer 228-1), the output of the selector 228-3-1 is not input to any one of the selectors 228-3. Rather, the selector 228-3-3 operates based on a control signal (“N_DMID_0” shown in FIG. 2C) provided from the selector 228-1-1. Similarly, the selectors 226-3 (when in a 2-tap DFE mode) and the selectors 228-3 select inputs based respectively on “N_DMID_0”, “N_DMID_1”, “N_DMID_2”, “N_DMID_3”, and “N_DMSB_0” provided from the slicer 221-1, as illustrated in FIG. 2B.

Rather, outputs of selectors 228-3 are provided to selectors 227-3 as shown in FIG. 2C. For example, an output of the selector 228-3-1 is provided to the selector 227-3-6; an output of the selector 228-3-2 is provided to the selector 227-3-8; an output of the selector 228-3-3 is provided to the selector 227-3-4; and an output of the selector 228-3-4 is provided to the selector 227-3-2. These outputs from the selectors 228-3 and provided to the selectors 227-3 are control signals being provided to the respective selectors 226 (e.g., selectors 226-3-2, 226-3-4, 226-3-6, and 226-3-8) in the 1-tap operation mode.

FIG. 3 illustrates an eye diagram illustrating a multi-level (e.g., PAM4) signal in accordance with various embodiments of the present disclosure. As illustrated in FIG. 3, the eye diagram further includes three regions (alternatively referred to as “slices”) respectively corresponding to a high-voltage sample (“DHIGH” shown in FIG. 3), mid-voltage sample (“DMID” shown in FIG. 3), and a low-voltage sample (“DLOW” shown in FIG. 3). The eye diagram further indicates that data eyes (e.g., data eyes 352-1, 352-2, and 352-3) are formed as signals transition from one state (e.g., high, low, mid-voltage state) to another state (e.g., high, low, mid-voltage state).

Each data eye can include a number of thresholds (e.g., “TH1”, “TH2”, “TH3”, “TH4” shown in FIG. 3) to which data signals sampled at sampling latches of slicers (e.g., slicers 221-1, 221-2, 221-3 illustrated in FIGS. 2A-2C, respectively). For example, “TH1”, “TH2”, “TH3”, “TH4” of the data eye 352-1 can correspond to four thresholds (e.g., +C1, +C1/3, −C1/3, and −C1 for the 1-tap operation mode and alternatively correspond to four different thresholds (e.g., 2/3(+C1+C2), 2/3(+C1−C2), 2/3(−C1+C2), and 2/3(−C1−C2) for the 2-tap DFE mode) that are utilized by the slicer 221-3, the data eye 352-2 can include other four thresholds (e.g.,), and the data eye 352-3 can include other four thresholds (e.g.,).

The signal illustrated in FIG. 3 can be sampled at different sampling times for determining a logical value of a symbol of the measured signal. For example, as illustrated in FIG. 3, the signal can be sampled at different sampling timings respectively corresponding to “Sample_0”, “Sample_1”, and “Sample_2”, which can respectively correspond to three different samples, 354-1, 354-2, and 354-3. Each sample of the PAM4 signal can correspond to a symbol, which represents one of four logical values (e.g., “00”, “01”, “10”, or “11”). The amplitudes 356-1, 356-2, 356-3, and 356-4 can respectively correspond to logical values “11”, “10”, “01”, and “00”. One sampled and resolved symbol can be used to resolve another symbol. For example, “Sample_0” can be used to resolve “Sample_1” and “Sample_1” can be used to resolve “Sample_2”.

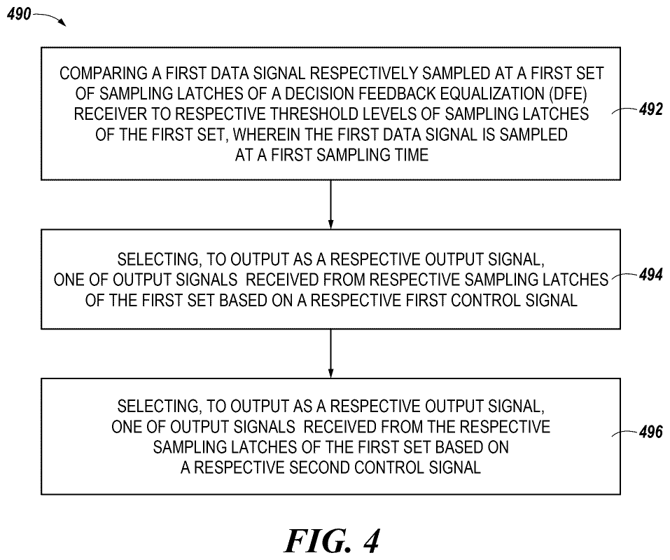

FIG. 4 illustrates an example method for switching among multiple equalization modes in accordance with various embodiments of the present disclosure. The method 490 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 490 is performed by the interface circuitry 113 of FIG. 1 (e.g., more particularly, a portion of the equalization circuitry 118, 218 at least partially illustrated in FIGS. 1 and 2A-2C. of FIGS. 2A-2C) and/or selection component 117 illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 492, a first data signal respectively sampled at a first set of sampling latches (e.g., the sampling latches 222-1, 222-2, 222-3 respectively illustrated in FIGS. 2A-2C) of a decision feedback equalization (DFE) receiver (e.g., a portion of the equalization circuitry 218 illustrated in FIGS. 2A-2C) can be compared to respective threshold levels of sampling latches 222-1, 222-2, 222-3 of the first set. In this example, the first data signal is sampled at a first sampling time.

At block 494, in a first operation mode (e.g., 1-tap DFE mode) of the DFE receiver and at each selector of a first set of selectors (e.g., the selectors 226-1, 226-2, 226-3 respectively illustrated in FIGS. 2A-2C), one of output signals received from respective sampling latches 222-1, 222-2, 222-3 of the first set can be selected (to output as a respective output signal) based on a respective first control signal. The first control signal can correspond to a second data signal sampled at a second sampling time preceding the first sampling time, which allows a symbol corresponding to the first data signal to be resolved based at least in part on a resolved symbol corresponding to the second data signal. As a result, a symbol corresponding to the first data signal can be resolved based on the resolved symbol corresponding to the second data signal.

At block 496, in a second operation mode (e.g., 2-tap DFE mode) of the DFE receiver and at each selector of the first set of selectors 226-1, 226-2, 226-3, one of output signals received from the respective sampling latches 222-1, 222-2, 222-3 of the first set can be selected (to output as a respective output signal) based on a respective second control signal. The second control signal can correspond to a third data signal sampled at a third sampling time preceding the second sampling time, which allows a symbol corresponding to the first data signal to be resolved based at least in part on a resolved symbol corresponding to the third data signal. A symbol corresponding to the first data signal can be resolved based on the resolved symbols corresponding to the second data signal and the third data signal that are respectively sampled at the second and third sampling times.

In some embodiments, in the first operation mode or the second operation mode, one of output signals received from respective selectors of the first set can be selected at each selector of a second set of selectors (e.g., the selectors 228-1, 228-2, 228-3 respectively illustrated in FIGS. 2A-2C) and as a respective output signal based on a respective third control signal. The respective third control signal can correspond to the second data signal sampled at the second sampling time and an output signal of a different one of the second set of selectors 228-1, 228-2, 228-3.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The figures herein follow a numbering convention in which the first digit or digits correspond to the drawing figure number and the remaining digits identify an element or component in the drawing. Similar elements or components between different figures may be identified by the use of similar digits. For example, 118 may reference element “18” in FIG. 1, and a similar element may be referenced as 218 in FIGS. 2A-2C. As will be appreciated, elements shown in the various embodiments herein can be added, exchanged, and/or eliminated so as to provide a number of additional embodiments of the present disclosure.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
comparing a first data signal respectively sampled at a first set of sampling latches of a decision feedback equalization (DFE) receiver to respective threshold levels of sampling latches of the first set, wherein the first data signal is sampled at a first sampling time;
in a first operation mode of the DFE receiver and at each selector of a first set of selectors:
selecting, to output as a respective output signal, one of a number of output signals received from respective sampling latches of the first set based on a respective first control signal, wherein the first control signal corresponds to a second data signal sampled at a second sampling time preceding the first sampling time, which allows a symbol corresponding to the first data signal to be resolved based at least in part on a resolved symbol corresponding to the second data signal; and
in a second operation mode of the DFE receiver and at each selector of the first set of selectors:
selecting, to output as a respective output signal, one of a number of output signals received from the respective sampling latches of the first set based on a respective second control signal, wherein the second control signal corresponds to a third data signal sampled at a third sampling time preceding the second sampling time, which allows a symbol corresponding to the first data signal to be resolved based at least in part on a resolved symbol corresponding to the third data signal.

2. The method of claim 1, further comprising, in the first operation mode or the second operation mode:
selecting, at each selector of a second set of selectors and as a respective output signal, one of the number of output signals received from respective selectors of the first set based on a respective third control signal, wherein:
the respective third control signal corresponds to:
the second data signal sampled at the second sampling time; and
an output signal of a different one of the second set of selectors.

3. The method of claim 2, further comprising, in the first operation mode:
resolving a symbol corresponding to the first data signal based on the resolved symbol corresponding to the second data signal.

4. The method of claim 2, further comprising, in the second operation mode:
resolving a symbol corresponding to the first data signal based on the resolved symbols corresponding to the second data signal and the third data signal that are respectively sampled at the second and third sampling times.

5. An apparatus for decision feedback equalization (DFE), comprising:
a first set of sampling latches of a DFE receiver, each sampling latch of the first set of sampling latches configured to:
sample a first data signal at a first sampling time; and
compare the respective first data signal to a respective threshold level;
a first set of selectors of the DFE receiver, each selector of the first set of selectors configured to:
receive a respective set of first output signals respectively from the first set of sampling latches;
in a first operation mode of the DFE receiver, select one of the respective set of first output signals based on a respective first control signal, wherein the respective first control signal corresponds to a second data signal sampled at a second sampling time preceding the first sampling time; and
in a second operation mode of the DFE receiver, select one of the respective set of first output signals based on a respective second control signal, wherein the respective second control signal corresponds to a third data signal sampled at a third sampling time preceding the second sampling time.

6. The apparatus of claim 5, further comprising a second set of selectors of the DFE receiver, each selector of the second set configured to:
receive a respective set of second output signals respectively from respective selectors of the first set; and
select, as a respective output signal, one of the respective set of second output signals based on a respective third control signal, wherein the respective third control signal corresponds to the second data signal sampled at the second sampling time.

7. The apparatus of claim 6, wherein the second data signal further corresponds to an output signal of a respective one of the set of second selectors.

8. The apparatus of claim 5, wherein the respective first data signal corresponds to a pulse amplitude modulation 4-level (PAM4) data signal, wherein the PAM4 data signal corresponds to:
a first slice;
a second slice corresponding to a voltage level higher than the first slice; or
a third slice corresponding to a voltage level higher than the second slice.

9. The apparatus of claim 8, wherein the respective second control signal corresponds to the second slice.

10. The apparatus of claim 9, wherein the respective first control signal data signal corresponds to the first slice or third slice.

11. The apparatus of claim 8, wherein the respective threshold levels of the first set of sampling latches correspond to, in the first operation mode, a number of thresholds within the second slice and per each symbol of the PAM4 signal.

12. The apparatus of claim 8, wherein the respective threshold levels of the first set of sampling latches correspond to, in the second operation mode, a number of thresholds within the second slice with:
a first portion of the number of thresholds corresponding to the second data signal; and
a second portion of the number of thresholds corresponding to the third data signal.

13. The apparatus of claim 5, wherein:
the first operation mode corresponds to a 1-tap DFE; and
the second operation mode correspond to a 2-tap DFE.

14. An apparatus for decision feedback equalization (DFE), comprising:
a first slicer comprising:
a first set of sampling latches configured to:
sample, at a first sampling time, a first data signal; and
compare the first data signal to respective threshold levels;
a first set of selectors, a respective selector of the first set configured to:
receive first output signals from respective sampling latches of the first set; and
select one of the received first output signals based on a first control signal received to a respective selector of the first set to output the selected one of the received first output signals, wherein the first control signal corresponds to:
a second data signal sampled at a second sampling time preceding the first sampling time when the DFE receiver operates in a first operation mode; and
a third data signal sampled at a third sampling time preceding the second sampling time when the DFE receiver operates in a second operation mode; and
a second set of selectors configured to:
receive second output signals from a respective pair of selectors of the first set; and
select one of the received second output signals based on a second control signal received to a respective selector of the second set to output the selected second output signal as a respective output of the first slicer, wherein the second control signal corresponds to the second data signal sampled at the second sampling time.

15. The apparatus of claim 14, wherein the third data signal corresponds to a respective output of a different selector of the second set.

16. The apparatus of claim 14, wherein the DFE receiver is to demodulate a pulse amplitude modulation 4-level (PAM4) and the first slicer corresponds to a first slice of slices of a PAM4 signaling scheme.

17. The apparatus of claim 16, further comprising a second slicer corresponding to a second slice of the slices of the PAM4 signaling scheme, the second slicer further comprising:
a second set of sampling latches configured to:
sample, at the first sampling time, the first data signal; and
compare the first data signal to respective threshold levels;
a third set of selectors, a respective selector of the third set configured to:
receive third output signals from respective sampling latches of the third set; and
select one of the received third output signals based on a third control signal received to a respective selector of the third set to output the selected one of the received third output signals, wherein the third control signal corresponds to:
the second data signal sampled at the second sampling time when the DFE receiver operates in the first operation mode; and
the third data signal sampled at the third sampling time when the DFE receiver operates in the second operation mode; and
a fourth set of selectors configured to:
receive fourth output signals from a respective pair of selectors of the third set; and
select one of the received fourth output signals based on a fourth control signal received to a respective selector of the fourth set to output the selected fourth output signal as a respective output of the second slicer, wherein the fourth control signal corresponds to the second data signal sampled at the second sampling time.

18. The apparatus of claim 17, further comprising a third slicer corresponding to a third slice of the slices of the PAM4 signaling scheme, the third slicer further comprising:
a third set of sampling latches configured to:
sample, at the first sampling time, the first data signal at respective clock signals; and
compare the first data signal to respective threshold levels;
a fifth set of selectors, a respective selector of the fifth set configured to:
receive fifth output signals from respective sampling latches of the fifth set; and
select one of the received fifth output signals based on a fifth control signal received to a respective selector of the fifth set to output the selected one of the received fifth output signals, wherein the fifth control signal corresponds to:
the respective second data signal sampled at the second sampling time when the DFE receiver operates in the first operation mode; and
the respective third data signal sampled at the third sampling time when the DFE receiver operates in the second operation mode; and
a sixth set of selectors configured to:
receive sixth output signals from a respective pair of selectors of the fifth set; and
select one of the received sixth output signals based on a sixth control signal received to a respective selector of the sixth set to output the selected sixth output signal as a respective output of the third slicer, wherein the sixth control signal corresponds to the second data signal sampled at the second sampling time.

19. The apparatus of claim 18, wherein the second data signal corresponds to a respective output of the second slicer or the third slicer.

20. The apparatus of claim 18, wherein:
the respective threshold levels of the second set of sampling latches corresponds to a second slice of the slices of the PAM4 signaling scheme; and
the respective threshold levels of the third set of sampling latches corresponds to a third slice of the slices of the PAM4 signaling scheme.
